(19) United States
(12) Patent Application Publication
(10) Pub. No.: US 2009/0128454 A1
(43) Pub. Date: May 21, 2009

(54) Plasma display device, and driving apparatus and method thereof

(76) Inventor: Jin-Ho Yang, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/289,974

(22) Filed: Nov. 7, 2008

(30) Foreign Application Priority Data
Nov. 16, 2007 (KR) 10-2007-0117272

(51) Int. Cl. G09G 3/28

(52) U.S. Cl. 345/60

(57) ABSTRACT

A plasma display device having a first switch is connected between the electrode and a first power supply that applies a high level voltage, and a second switch is connected between the electrode and a second power supply that applies a low level voltage. A capacitor for collecting power is connected to one end of at least one inductor. A first diode and a third switch are coupled in series between the electrode and a second end of at least one of the inductors. Also, a second diode and a fourth switch are coupled in series between the electrode and a second end of at least one of the inductors. Here, a clamping circuit unit connected to the second end of at least one of the inductors absorbs resonance energy generated by at least one of the inductors when the first and second switches are turned on.

### CLAIM OF PRIORITY

This application makes reference to, incorporates the same herein, and claims all benefits accruing under 35 U.S.C. §119 from an application earlier filed in the Korean Intellectual Property Office on Nov. 16, 2007 and there duly assigned Serial No. 10-2007-0117272.

### BACKGROUND OF THE INVENTION

1. Field of the Invention

The present invention relates to a plasma display device, and a driving apparatus and a driving method thereof. More particularly, the present invention relates to a sustain discharge circuit.

2. Description of the Related Art

A plasma display device is a display device using a plasma display panel (PDP) that displays texts or images using plasma generated by gas discharge. Such a plasma display panel includes a plurality of discharge cells arranged in a matrix format.

A plasma display device is driven by dividing a frame into a plurality of subfields and displays grayscales by combination of weight values of subfields that perform a display operation among the plurality of subfields. Light emitting cells and non-light emitting cells are selected during an address period of each subfield, and a sustain discharge operation is performed for the light emitting cells in order to display images during a sustain period.

In order to perform the sustain discharge operation, a high level voltage and a low level voltage are alternately applied to an electrode that performs the sustain discharge operation during the sustain period. Here, it is necessary to have a reactive power to alternately apply a high level voltage and a low level voltage to the electrode because two electrodes where sustain discharge is induced operate as capacitive components. Therefore, an energy recovery circuit is used as a sustain discharge circuit of the plasma display device. The energy recovery circuit collects reactive power and reuses the collected reactive power.

Such an energy recovery circuit uses resonance induced within an inductor connected to an electrode that performs a sustain discharge operation. Here, an electrode is connected to one end of the inductor and a clamping diode is connected to the other end of the inductor. The clamping diode prevents the voltage at the other end from exceeding an allowable voltage. Therefore, a free-wheeling current that passes through the clamping diode is generated due to characteristics of the inductor when a high level voltage is applied to the electrode or when a low level voltage is applied to the electrode after the voltage of the electrode is decreased using the resonance induced within the inductor.

Due to the free-wheeling current, the inductor looses energy stored therein. The voltage of the electrode becomes lower than the high level voltage before increasing the voltage of the electrode using the resonance due to the free-wheeling current. The voltage of the electrode becomes higher than the low level voltage before decreasing the voltage of the electrode using the resonance. That is, the energy recovery rate deteriorates if voltages at both ends of the inductor are insufficient.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device, and a driving apparatus and a driving method thereof, having advantages of improving an energy recovery rate in a sustain discharge circuit.

An exemplary embodiment of the present invention provides a plasma display device including an electrode, a first switch, a second switch, at least one of inductors, a third switch, a fourth switch, a first diode, a second diode, and a clamping circuit unit. The first switch is connected between the electrode and a first power supply that applies a first voltage. The second switch is connected between the electrode and a second power supply that applies a second voltage. At least one of inductors includes a first end connected to a third power supply that applies a third voltage that is an intermediate voltage between the first voltage and the second voltage. The third switch is connected between a second end of at least one of the inductors and the electrode. The fourth switch is connected between a second end of at least one of the inductors and the electrode. The first diode is connected between the second end of at least one of the inductors and the electrode and forms a path that increases a voltage of the electrode when the third switch is turned on. The second diode is connected between the second end of at least one of the inductors and the electrode, and forms a path that decreases a voltage of the electrode when the fourth switch is turned on. The clamping circuit unit absorbs resonance energy generated by at least one of the inductors when the first and second switches are turned on.

Another exemplary embodiment of the present invention provides a method for driving a plasma display device having an electrode. The driving method includes, in a sustain period, increasing a voltage of the electrode through a first path that includes a first inductor having a first end connected to a first power supply that applies a first voltage and a first switch connected between a second end of the first inductor and the electrode, and applying a second voltage that is higher than the first voltage to the electrode. Here, the applying of the second voltage includes absorbing resonance energy generated by the first inductor.

Another exemplary embodiment of the present invention provides a driving apparatus for a plasma display device having an electrode. The driving apparatus includes a first switch, a second switch, a rising path, a falling path, and a clamping circuit unit. The first switch is connected between the electrode and a first power supply that supplies a first voltage. The second switch is connected between the electrode and a second power supply that applies a second voltage that is lower than the first voltage. The rising path includes a first diode and a third switch coupled in series between the first inductor and the electrode, and increases a voltage of the electrode when the third switch is turned on. The falling path includes a second diode and a fourth switch coupled in series between the second inductor and the electrode, and decreases a voltage of the electrode when the fourth switch is turned on. The clamping circuit unit absorbs resonance energy generated by the first inductor and the second inductor when the first and second switches are turned on.

According to an exemplary embodiment of the present invention, an energy collecting rate can be improved by absorbing resonance energy when an energy recovery circuit is used in a sustain period.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components.

FIG. 1 is a schematic diagram illustrating a plasma display device according to an exemplary embodiment of the present invention

FIG. 2 is a diagram illustrating a driving waveform of a plasma display device according to a first exemplary embodiment of the present invention.

FIG. 3 and FIG. 4 are diagrams illustrating a sustain discharge circuit according to first and second exemplary embodiments of the present invention, respectively.

FIG. 5 is a diagram illustrating a driving waveform of a plasma display device according to the second exemplary embodiment of the present invention.

FIG. 6 is a diagram illustrating a sustain discharge circuit according to a third exemplary embodiment of the present invention.

FIG. 7 is a signal timing diagram of a sustain discharge circuit according to the first exemplary embodiment of the present invention.

FIG. 8A and FIG. 8B are diagrams illustrating a sustain discharge circuit in a mode 2 and a mode 4 of FIG. 7.

FIG. 9 through and including FIG. 14 are diagrams illustrating a sustain discharge circuit according to fourth to ninth exemplary embodiments of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. Throughout this specification and the claims that follow, when it is described that an element is “coupled” to another element, the element may be “directly coupled” to the other element or “electrically coupled” to the other element through a third element.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. Since a threshold voltage of a semiconductor element such as a transistor and a diode is significantly lower than a discharge voltage, the threshold voltage is treated as a 0V voltage. Therefore, a voltage applied to a node or an electrode by a power supply includes voltages with a threshold voltage and parasitic components induced from a voltage of the power supply.

Hereinafter, a plasma display device, and a driving apparatus and a driving method thereof according to an exemplary embodiment of the present invention will be described.

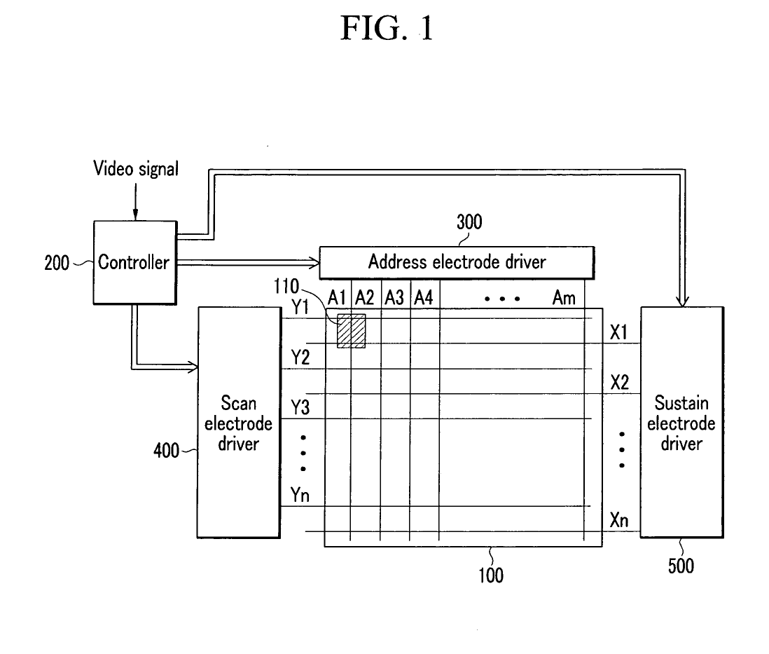

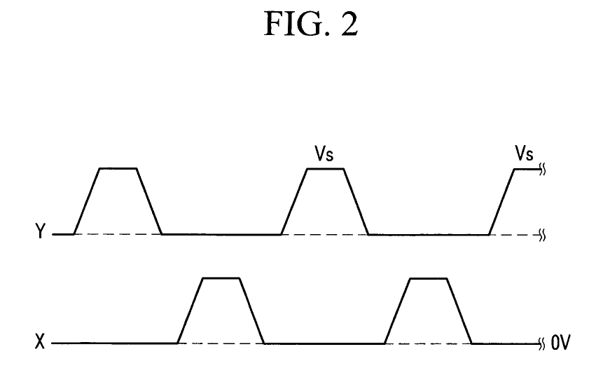

FIG. 1 is a schematic diagram illustrating a plasma display device according to an exemplary embodiment of the present invention, and FIG. 2 is a diagram illustrating a driving waveform of a plasma display device according to a first exemplary embodiment of the present invention. In FIG. 2, a driving waveform for a sustain period of an X electrode and a Y electrode are only shown for better understanding and ease of description.

As shown in FIG. 1, the plasma display device according to an exemplary embodiment of the present invention includes a plasma display panel (PDP) 100, a controller 200, an address electrode driver 300, a scan electrode driver 400, and a sustain electrode driver 500.

The plasma display panel (PDP) 100 includes a plurality of address electrodes A1 to An extending in a column direction, and a plurality of sustain electrodes X1 to Xn and scan electrodes Y1 to Yn, which extend in a row direction as pairs. The address electrodes A1 to An are referred as “A electrodes”, the sustain electrodes are referred as “X electrodes”, and the scan electrodes are referred as “Y electrodes”. In general, the X electrodes X1 to Xn are formed corresponding to the Y electrodes Y1 to Yn, and the X electrodes X1 to Xn and the Y electrodes Y1 to Yn perform display operations for displaying an image in a sustain period. The Y electrodes Y1 to Yn and the X electrodes X1 to Xn perpendicularly cross the A electrodes A1 to Am. Here, a cell 110 is formed at a discharge space at a crossing area of the A electrodes A1 to Am and the X and Y electrodes X1 to Xn and Y1 to Yn. This is an exemplary structure of the PDP 100, and panels of other structures can be applied to the present invention.

The controller 200 receives a video signal from an external device and outputs an A electrode driving control signal, an X electrode driving control signal, and an Y electrode driving control signal. The controller 200 drives the plasma display panel by dividing one frame into a plurality of subfields.

The address electrode driver 300 applies a driving voltage to the A electrodes A1 to Am in response to the driving control signal from the controller 200.

The scan electrode driver 400 applies a driving voltage to the Y electrodes Y1 to Yn in response to the driving control signal from the controller 200.

The sustain electrode driver 500 applies a driving voltage to the X electrodes X1 to Xn in response to the driving control signal from the controller 200.

In detail, the address electrode, scan electrode, and sustain electrode drivers 300, 400, and 500 select light emitting cells and non-light emitting cells from a plurality of cells 110 for a corresponding subfield during an address period of each subfield. As shown in FIG. 2, the scan electrode driver 400 applies a sustain pulse that alternately has a high level voltage Vs and a low level voltage 0V to the Y electrodes Y1 to Yn as many as a predetermined number of times corresponding to a weight value of a corresponding subfield during a sustain period of each subfield. The sustain electrode driver 500 applies a sustain pulse to the X electrodes X1 to Xn with an opposite phase to that of the sustain pulse applied to the Y electrodes Y1 to Yn. Then, a voltage difference of each Y electrode Y1 to Yn and each X electrode X1 to Xn alternately has a voltage of Vs and a voltage of −Vs. Accordingly, a sustain discharge is repeatedly induced at the light emitting cell as many as the predetermined number of times.

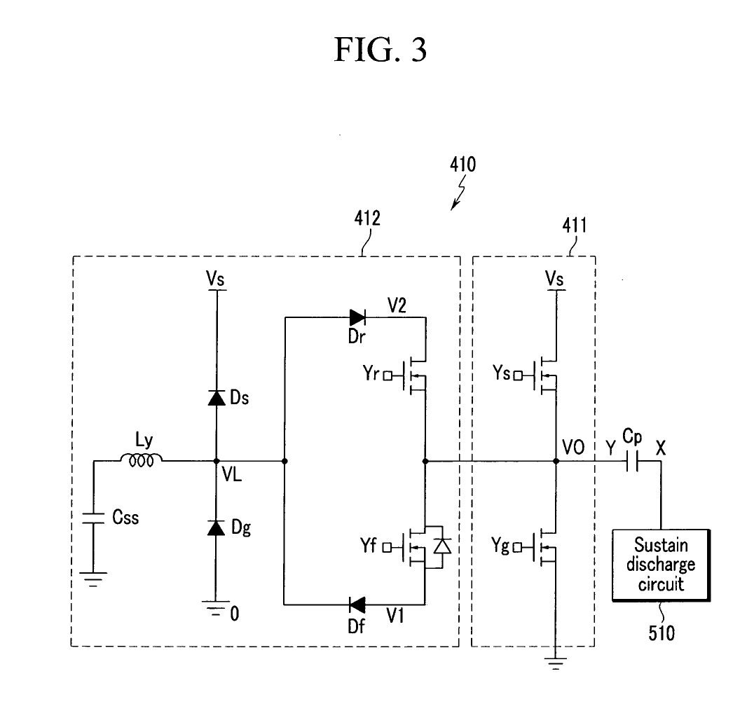

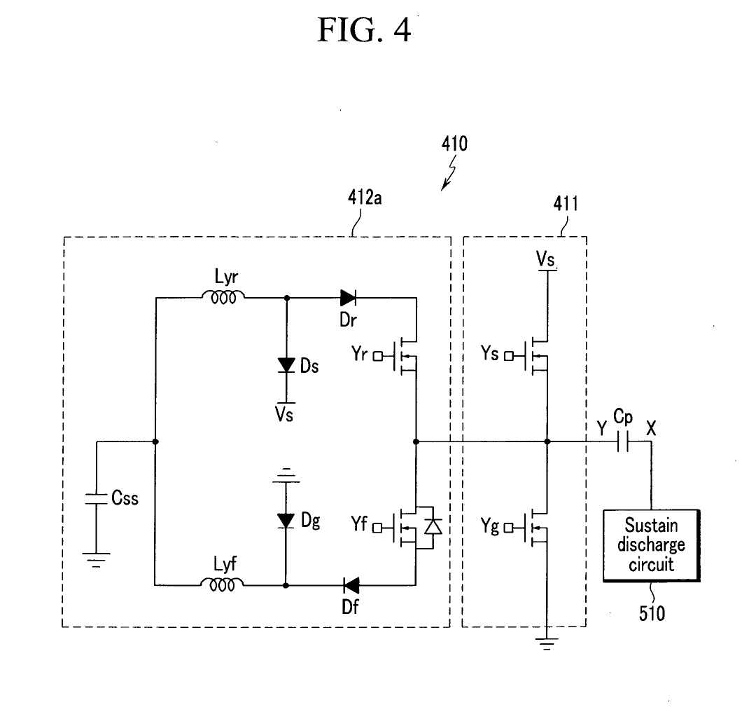

Hereinafter, a sustain discharge circuit for applying a sustain pulse to the Y electrodes Y1 to Yn will be described with reference to FIG. 3 and FIG. 4.

FIG. 3 and FIG. 4 are diagrams illustrating a sustain discharge circuit according to the first and second exemplary embodiments of the present invention. In FIG. 3 and FIG. 4, the sustain discharge circuit 410 is commonly connected to the Y electrodes Y1 to Yn, and a sustain discharge circuit 510 is commonly connected to the X electrodes X1 to Xn. Here, the sustain discharge circuit 510 is identical to the sustain discharge circuit 410. In FIG. 3 and FIG. 4, only one X electrode and one Y electrode are shown, and a panel capacitor Cp is shown as a capacitive component for better understanding and ease of description. In FIG. 3 and FIG. 4, transistors Ys, Yr, Yf, and Yg are n-channel field effect transistors. Particularly, the transistors Ys, Yr, Yf, and Yg are n-channel metal oxide semiconductor (NMOS) transistors. Body diodes may be formed in a direction from a source to a drain at the transistors Ys, Yr, Yf, and Yg. Instead of the NMOS transistors, other transistors having a similar function may be used as the transistors Ys, Yr, Yf, and Yg. Although each of the transistors Ys, Yr, Yf, and Yg are shown as one transistor, each of the transistors Ys, Yr, Yf, and Yg may be formed of a plurality of transistors coupled in parallel.

As shown in FIG. 3, the sustain discharge circuit 410 according to the first exemplary embodiment of the present invention includes a sustain discharge unit 411 and an energy recovery unit 412. The sustain discharge unit 411 includes transistors Ys and Yg, and the energy recovery unit 412 includes transistors Yr and Yf, an inductor Ly, a capacitor Css, and diodes Dr, Df, Ds, and Dg.

In detail, the transistor Ys has a drain connected to a power supply Vs that applies a high level voltage Vs, and a source connected to the Y electrode. The transistor Yg includes a source connected to a power supply such as a ground end that applies a low level voltage 0V, and a drain connected to the Y electrode.

A source of the transistor Yr and a drain of the transistor Yf are connected to the Y electrode, and a drain of the transistor Yr and a source of the transistor Yf are connected to one end of the inductor Ly. The other end of the inductor Ly is connected to the capacitor Css, which is a power supply for energy recovery. A diode Dr is connected between one end of the inductor Ly and the drain of the transistor Yr, and the diode Df is connected between one end of the inductor Ly and the source of the transistor Yf. Here, the capacitor Css applies a voltage between the high level voltage Vs and the low level voltage 0V. Particularly, the capacitor Css applies an intermediate voltage Vs/2 that is between the two voltages Vs and 0V. The diode Dr sets a current path, which will be referred as a “rising path”, for increasing a voltage of the Y electrode, and the diode Df sets a current path, which will be referred as a “falling path”, for decreasing a voltage of the Y electrode. The positions of the diode Dr and the transistor Yr may be switched, and the positions of the diode Df and transistor Yfm may also be switched.

Also, one end of the inductor Ly is connected to an anode, and a cathode of the diode Ds is connected to a power supply Vs. A cathode is connected to one end of the inductor Ly and a ground is connected to the anode of the diode Dg. The diodes Ds and Dg perform a clamping function for preventing a voltage at one end of the inductor Ly from abruptly changing or from exceeding an allowable voltage. Therefore, the diodes Ds and Dg operate as a clamping unit.

Unlike FIG. 3, the sustain discharge circuit 410 according to the second exemplary embodiment of the present invention may include inductors connected on a rising path and a falling path. As shown in FIG. 4, one end of an inductor Lyr is connected to an anode of a diode Dr, one end of an inductor Lyf is connected to a cathode of a diode Df, and the other ends of the inductors Lyr and Lyf are connected to a capacitor Css in an energy recovery unit 412a according to the second embodiment of the present invention. In this case, a diode Ds is connected between one end of the inductor Lyr and a power supply Vs, and a diode Dg may be connected between one end of the inductor Lyf and a ground end.

Meanwhile, as a high level voltage and a low level voltage of a sustain pulse, voltages that are different from Vs and 0V may be used.

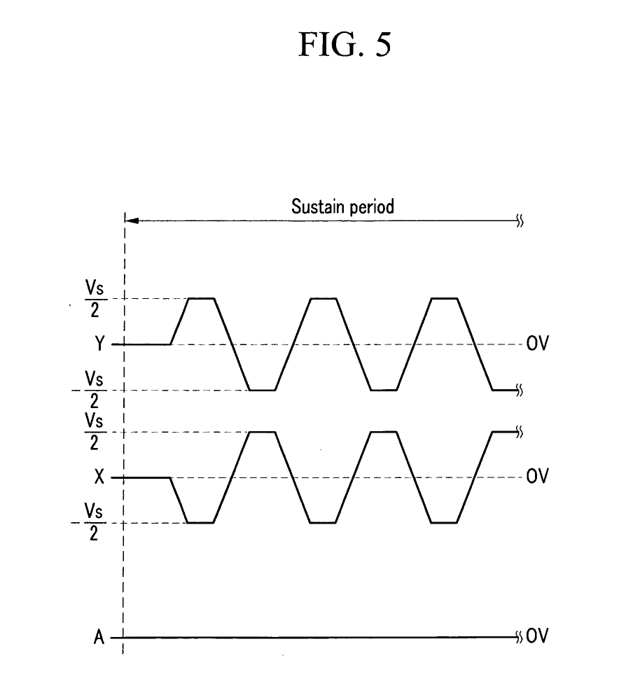

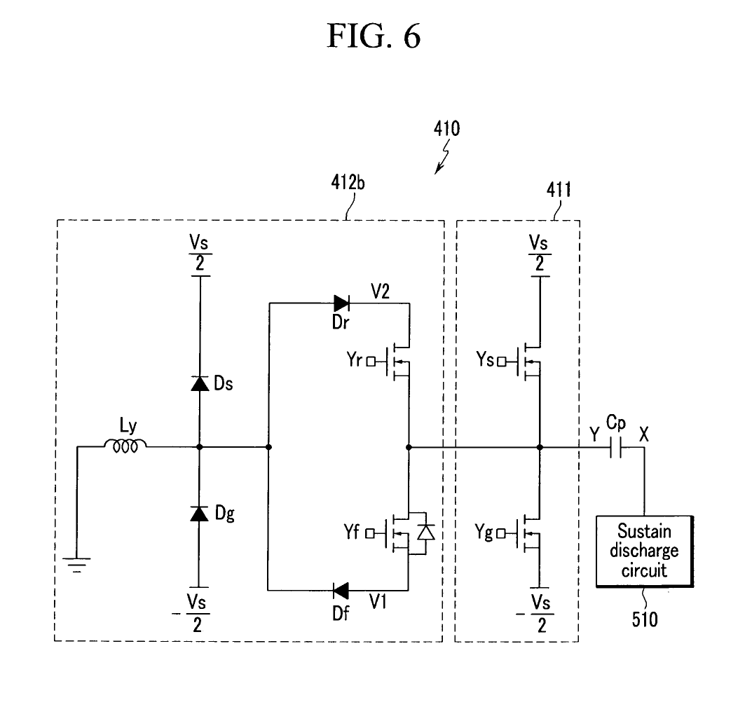

FIG. 5 is a diagram illustrating a driving waveform of a plasma display device according to the second exemplary embodiment of the present invention, and FIG. 6 is a diagram illustrating a sustain discharge circuit according to the third exemplary embodiment of the present invention.

As shown in FIG. 5, a voltage of Vs/2 is used as a high level voltage of the sustain pulse, and a voltage of −Vs/2 is used as a low level voltage of a sustain pulse. Since the voltage difference between the Y electrodes Y1 to Yn and the X electrodes X1 to Xn alternately has a voltage of Vs and a voltage of −Vs, even though the voltage of Vs/2 and the voltage of −Vs/2 are used as the high level voltage and the low level voltage, sustain discharge may be induced at the light emitting cells.

In the sustain discharge circuit 410 in FIG. 3 and FIG. 4, the power supply Vs connected to the cathodes of the transistor Ys and the diode Ds may be replaced with a power supply that applies a voltage of Vs/2, and the ground end connected to the anodes of the transistor Yg and the diode Dg may be replaced with a power supply that applies a voltage of −Vs/2. In this case, a voltage of Vs/2 and a voltage of −Vs/2 can be applied to the Y electrodes.

Since the sustain pulse according to the second exemplary embodiment of the present invention may then have a high level voltage of Vs/2 and a low level voltage of −Vs/2, the intermediate voltage of the high level voltage and the low level voltage of the sustain pulse is 0V. Therefore, the energy recovery unit 412b according to the third exemplary embodiment of the present invention may not need a capacitor (Css in FIG. 3 and FIG. 4).

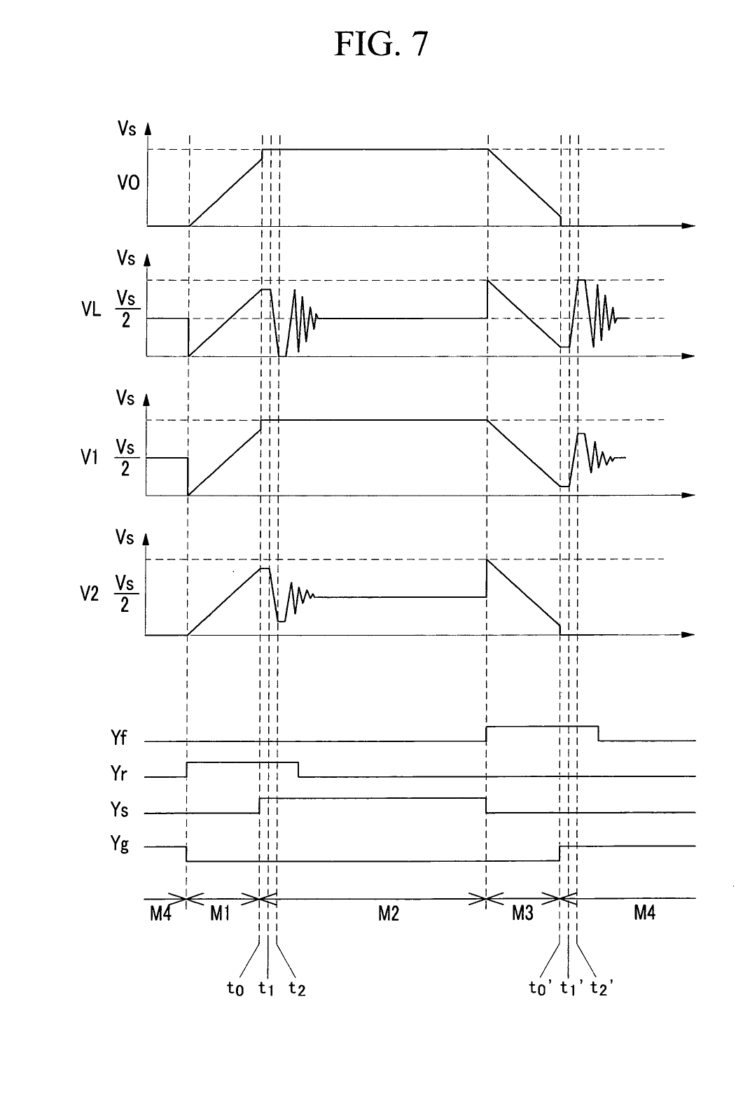

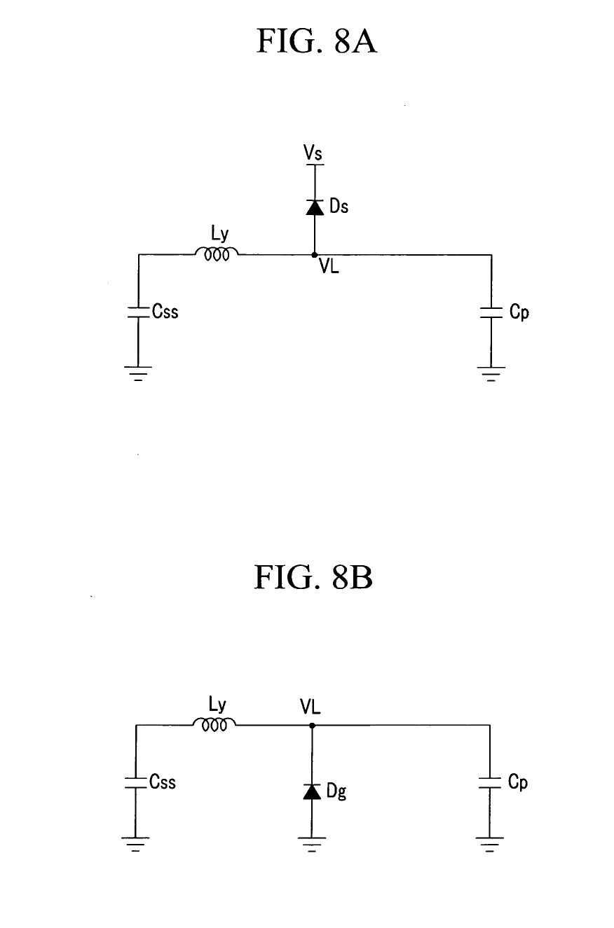

Hereinafter, operations of the sustain discharge circuit according to the first exemplary embodiment of the present invention will be described with reference to FIG. 7 and FIG. 8A.

FIG. 7 is a signal timing diagram of a sustain discharge circuit according to the first exemplary embodiment of the present invention, and FIG. 8A and FIG. 8B are diagrams illustrating a sustain discharge circuit in a mode 2 and a mode 4 of FIG. 7. In FIG. 7, it is assumed that the transistor Yg is turned on and 0V is applied to a Y electrode in a mode 4 M4 which is right before a mode 1 M1. In FIG.7, “VO” denotes a voltage of the Y electrode of a panel capacitor Cp, and “V1” denotes an anode voltage of a diode Df. “V2” denotes a cathode voltage of a diode Dr, and “VL” denotes a voltage at one end of an inductor Ly.

In the mode 1 M1, the transistor Yg is turned off and the transistor Yr is turned on. Then, a current path is formed through the capacitor Css, the inductor Ly, the diode Dr, the transistor Yr, and the Y electrode of the panel capacitor Cp. Here, resonance is induced between the panel capacitor Cp and the inductor Ly. The resonance increases the voltages VO and VL.

In a mode 2 M2, the transistor Yr is turned off, and the transistor Ys is turned on. Then, the voltage VO is changed to the voltage Vs while forming a current path through the power supply Vs, the transistor Ys, and the Y electrode of the panel capacitor Cp. After current is changed to a reverse direction at regions t₀ to t₁, current passes as it is until the diode Dr starts blocking the current. Since the diode Dr is converted to reverse bias at regions t₁ to t₂, voltages VL, V1, and V2 are changed at different rates. As shown in FIG. 8A, a circuit viewed from the inductor Ly to the Y electrode may be equivalent to one capacitor Cp which is the sum of junction capacitances. Therefore, voltages VL and V2 are changed while resonance is induced between the inductor Ly and the capacitor Cp after a region t₂. That is, the current flowing through the inductor Ly is diffused as the resonant energy, and a free-wheeling current does not flow in the transistor Ys.

In a mode 3 M3, the transistor Ys is turned off, and the transistor Yf is turned on. Then, a current path is formed through the Y electrode of the panel capacitor Cp, the transistor Yf, the diode Df, the inductor Ly, and the capacitor Css. Here, resonance is induced between the panel capacitor Cp and the inductor Ly. The resonance reduces voltages VO and VL.

In a mode 4 M4, the transistor Yf is turned off, and the transistor Yg is turned on. Then, a current path is formed through the Y electrode of the panel capacitor Cp, the transistor Yg, and the ground end, and the voltage VO becomes 0V. Like the mode 2 M2, the current is changed to the reverse direction and flows as it is until the diode Df blocks the current to not flow any more at regions t₀′ to t₁′ in the mode 4 M4. Since the diode Df is converted to a reverse bias in the regions t₁′ to t₂′, voltages VL, V1, and V2 are changed at different rates. As shown in FIG. 8B, a circuit viewed from the inductor Ly to the Y electrode is equivalent to one capacitor Cp that is the sum of each of the junction capacitances. Therefore, resonance is induced between the inductor Ly and the capacitor Cp and the voltages VL and V1 are changed at regions after the region t₂′. That is, the current flowing through the inductor Ly is diffused as resonant energy, and a free-wheeling current does not flow through the transistor Yg.

During a sustain period, the sustain discharge circuit 410 can alternately apply 0V and Vs to the Y electrode by repeating the operations of the modes 1 to 4 M1 to M4 as many times as a predetermined number corresponding to a weight value of a corresponding subfield.

Since the free-wheeling current does not flow in the sustain discharge circuit according to the first exemplary embodiment of the present invention as described above, the energy recovery rate may increase compared to that of any conventional art.

Operations and effects of the sustain discharge circuit shown in FIG. 4 and FIG. 6 are also identical to those of the sustain discharge circuit shown in FIG. 3.

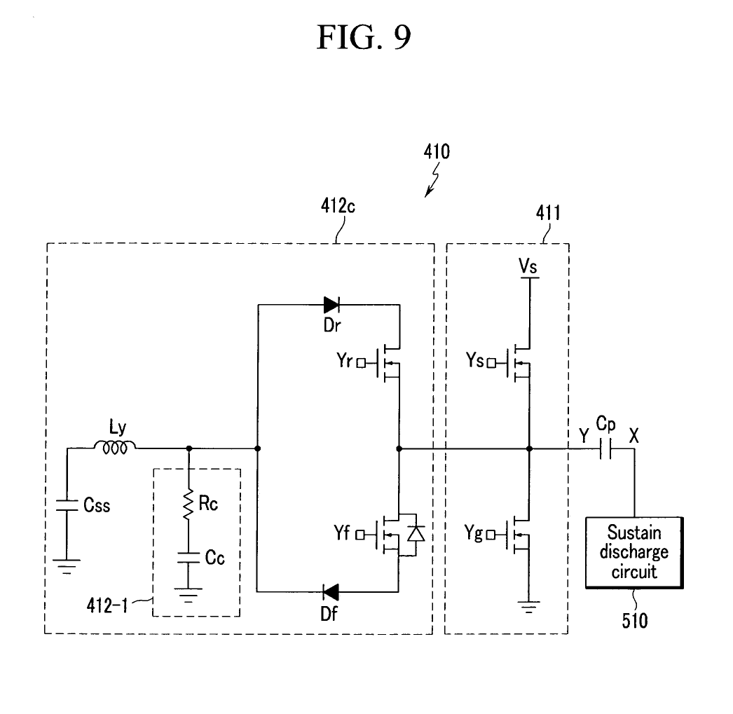

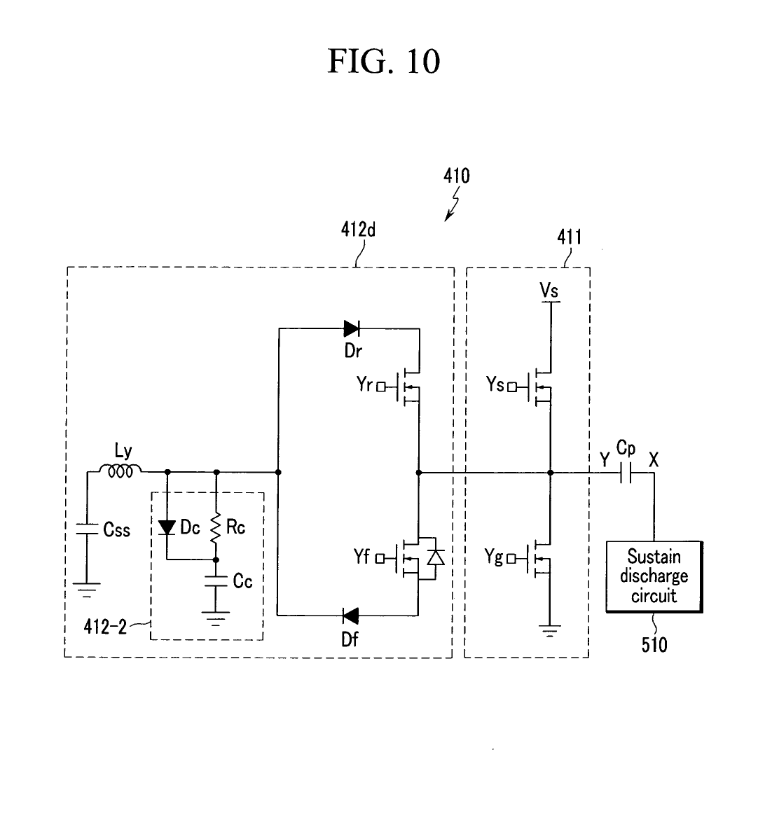

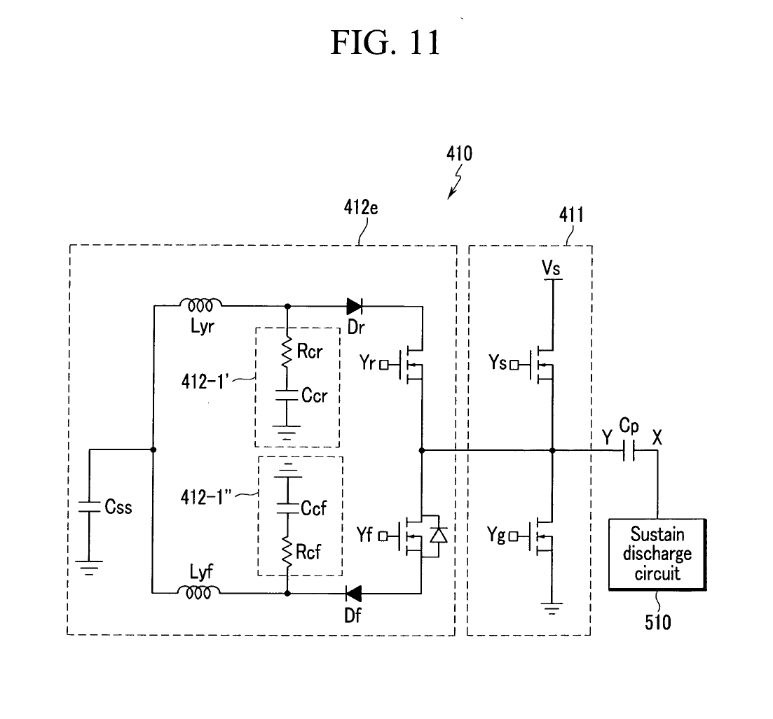

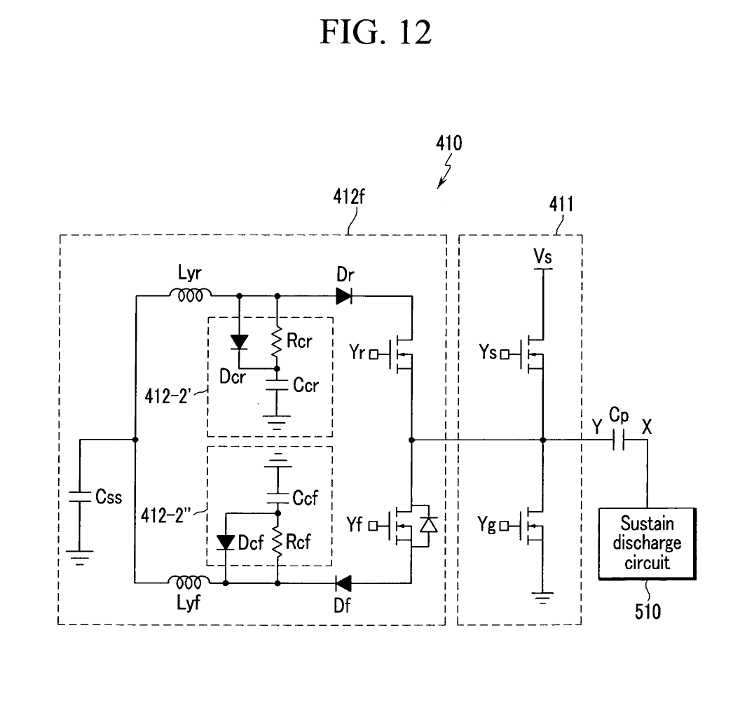

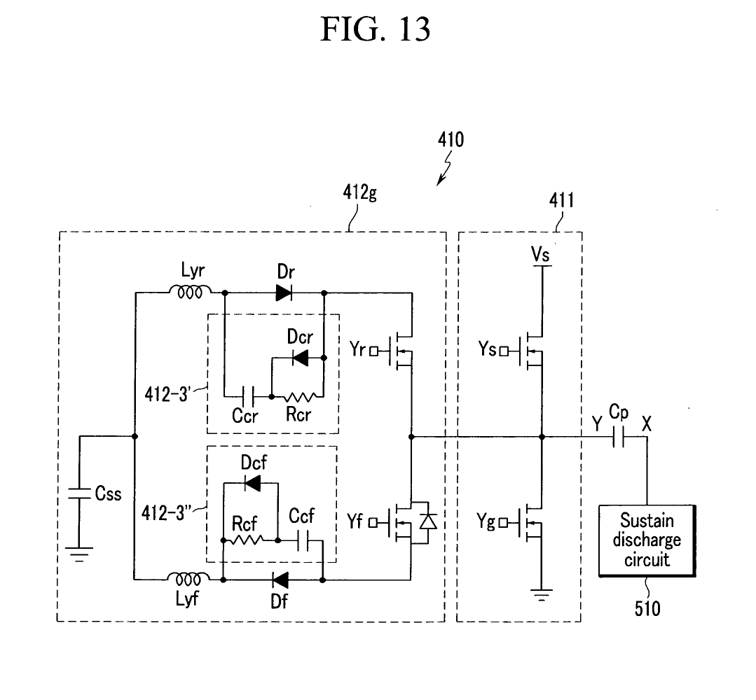

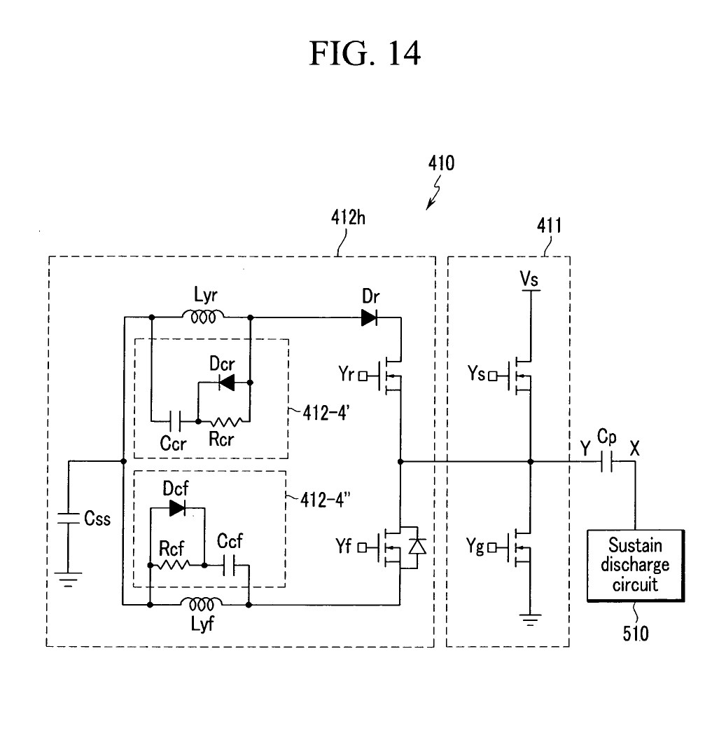

Hereinafter, a sustain discharge circuit according to fourth to seventh exemplary embodiments of the present invention will be described with reference to FIG. 9 to FIG. 12.

FIG. 9 to FIG. 12 are diagrams illustrating a sustain discharge circuit according to the fourth to seventh exemplary embodiments of the present invention.

As shown in FIG. 9, the energy recovery unit 412c according to the fourth exemplary embodiment of the present invention is identical to that according to the first exemplary embodiment except that the energy recovery unit 412c includes a clamping circuit unit 412-1 instead of the diodes Ds and Dg.

The clamping circuit unit 412-1 includes a resistor Rc and a capacitor Cc. The resistor Rc is connected to one end of the inductor Ly, and the capacitor Cc is connected between the resistor Rc and a ground end. Here, the capacitance of the capacitor Cc is larger than that of the capacitor Cp. Therefore, the resistor Rc and capacitor Cc absorb resonance energy between the inductor Ly and the capacitor Cp when a voltage Vs is applied to the Y electrode and when 0V is applied to the Y electrode, for example at M2 and M4 of FIG. 7. That is, the resonance between the capacitor Cc and the inductor Ly becomes a major component if the capacitance of the capacitor Cc becomes larger than that of the capacitor Cp when the voltage Vs is applied to the Y electrode and when 0V is applied to the Y electrode. Here, a stable voltage can be applied to the Y electrode because the resistor Rc reduces the energy at a fast rate. Here, the resistance value of the resistor Rc is determined by a peak value of the current flowing through the inductor Ly, and the capacitance of the capacitor Cc is determined according to the capacitor Cp.

As shown in FIG. 10, the energy recovery unit 412d according to the fifth exemplary embodiment of the present invention is identical to that according to the fourth exemplary embodiment of the present invention except that the clamping circuit unit 412-2 further includes a diode Dc. Here, an anode of the diode Dc is connected to one end of the inductor Ly, and a cathode of the diode Dc is connected between the resistor Rc and the capacitor Cc. The diode Dc can prevent the VL voltage from increasing quickly by forming a current path from the capacitor Cc to the ground end when the voltage VL abruptly increases.

Although the clamping circuit units 412-1 and 412-2 are applied to the sustain discharge circuit 410 according to the first exemplary embodiment of the present invention in FIG. 9 and FIG. 10, the clamping circuit units 412-1 and 412-2 can be applied to the sustain discharge circuit 410 according to the second and third exemplary embodiments of the present invention.

FIG. 11 shows a sustain discharge circuit embodied by applying the clamping circuit unit 412-1 of FIG. 9 to the sustain discharge circuit 410 according to the second exemplary embodiment of the present invention, and FIG. 12 shows a sustain discharge circuit embodied by applying the clamping circuit 412-2 of FIG. 10 to the sustain discharge circuit 410 according to the second exemplary embodiment of the present invention.

As shown in FIG. 11, the energy recovery unit 412e according to the sixth exemplary embodiment of the present invention includes a clamping circuit unit 412-1′ and a clamping circuit unit 412-1′. The clamping circuit unit 412-1′ include a resistor Rcr and a capacitor Ccr coupled in series between a junction of an inductor Lyr and a diode Dr, and a ground end. The clamping circuit unit 412-1″ includes a resistor Rcf and a capacitor Ccf coupled in series between a junction of an inductor Lyf and a diode Df, and a ground end.

As shown in FIG. 12, the energy recovery unit 412f according to the seventh exemplary embodiment of the present invention also includes a clamping circuit unit 412-2′ and a clamping circuit unit 412-2″. The clamping circuit unit 412-2′ includes a resistor Rcr and a capacitor Ccr coupled in series between a junction of an inductor Lyr and a diode Dr, and a ground end, and a diode Dcr coupled to the resistor Rcr in parallel. Also, the clamping circuit unit 412-2″ includes a resistor Rcf and a capacitor Ccf coupled in series between a junction of an inductor Lyf and a diode Df, and a ground end, and a diode Dcf coupled to the resistor Rcf in parallel.

Although unlikely, the clamping circuit units 412-1 and 412-2 may be connected to a power supply for applying a voltage, not a ground end. That is, the clamping circuit units 412-1 and 412-2 may be a power supply Vs.

Meanwhile, other clamping circuits performing operations similar to those of the clamping circuit units 412-1 and 412-2 of FIG. 9 and FIG. 10 may be applied to the sustain discharge circuit 410 according to the first to third exemplary embodiments. Hereinafter, these clamping circuits will be described with reference to FIG. 13 and FIG. 14.

FIG. 13 and FIG. 14 are diagrams illustrating sustain discharge circuits according to the eighth and ninth exemplary embodiments of the present invention.

As shown in FIG. 13, the energy recovery unit 412g according to the eighth exemplary embodiment of the present invention includes a clamping circuit unit 412-3′ and a clamping circuit unit 412-3″. The clamping circuit unit 412-3′ includes a resistor Rcr and a capacitor Ccr coupled in series between an anode of the diode Dr and a cathode of the diode Dr, and a diode Dcr coupled to the resistor Rcr in parallel. Also, the clamping circuit unit 412-3″ of the energy recovery unit 412h includes a resistor Rcf and a capacitor Ccf coupled in series between a cathode and an anode of a diode Df, and a diode Dcf coupled to the resistor Rcf in parallel.

Unlike FIG. 13, an energy recovery unit 410h according to the ninth exemplary embodiment of the present invention includes a clamping circuit unit 412-4′ and a clamping circuit unit 412-4″. The clamping circuit unit 412-4′ may include a resistor Rcr and a capacitor Ccr coupled in series between both ends of an inductor Lyr. Also, the clamping circuit unit 412-4″ may include a resistor Rcf and a capacitor Ccf coupled in series between both ends of the inductor Lyf. In the sustain discharge circuits 410e to 410h according to the sixth to ninth exemplary embodiments of the present invention, the operations and effects of the clamping circuit units 412-1′, 412-1″, 412-2′, 412-2″, 412-3′, 412-3″, 412-4′, and 412-4″ are identical to those of the clamping circuit units 412-1 and 412-2 of the sustain discharge circuit according to the fourth and fifth exemplary embodiments of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
an electrode;
a first switch connected between the electrode and a first power supply that applies a first voltage;
a second switch connected between the electrode and a second power supply that applies a second voltage;
at least one of inductors each having a first end connected to a third power supply that applies a third voltage that is an intermediate voltage between the first voltage and the second voltage;
a third switch connected between a second end of at least one of the inductors and the electrode;
a fourth switch connected between a second end of at least one of the inductors and the electrode;
a first diode connected between the second end of at least one of the inductors and the electrode and forming a path that increases a voltage of the electrode when the third switch is turned on;
a second diode connected between the second end of at least one of the inductors and the electrode, and forming a path that decreases a voltage of the electrode when the fourth switch is turned on; and
a clamping circuit unit for absorbing resonance energy generated by at least one of the inductors when the first and second switches are turned on.

2. The plasma display device of claim 1, wherein the clamping circuit includes a resistor and a first capacitor coupled in series between the second end of at least one of the inductors and the first power supply.

3. The plasma display device of claim 2, wherein the second voltage is higher than the first voltage, the resistor is connected to the second end of at least one of the inductors, and the first capacitor is connected to the first power supply.

4. The plasma display device of claim 2, wherein the clamping circuit unit further includes a third diode coupled to the resistor in parallel.

5. The plasma display device of claim 1, wherein the clamping circuit unit includes a capacitor and a resistor coupled in series between an anode and a cathode of the first diode and between an anode and a cathode of the second diode.

6. The plasma display device of claim 5, wherein the clamping circuit unit further includes a third diode coupled to the resistor in parallel.

7. The plasma display device of claim 1, wherein the clamping circuit unit includes a capacitor and a resistor coupled in series between the first end and the second end of at least one of the inductors.

8. The plasma display device of claim 7, wherein the clamping circuit unit further includes a third diode coupled to the resistor in parallel.

9. The plasma display device of claim 1, wherein the third power supply includes a capacitor for charging the third voltage.

10. The plasma display device of claim 1, wherein the first voltage is a positive voltage and the second voltage is a negative voltage having an absolute value identical to the first voltage.

11. A method for driving a plasma display device having an electrode, comprising, in a sustain period:
increasing a voltage of the electrode through a first path that includes a first inductor having a first end connected to a first power supply that applies a first voltage and a first switch connected between a second end of the first inductor and the electrode; and
applying a second voltage that is higher than the first voltage to the electrode,
wherein the applying of the second voltage includes absorbing resonance energy generated by the first inductor.

12. The method of claim 11, further comprising,
in the sustain period:
decreasing a voltage of the electrode through a second path that includes a second inductor having a first end connected to the first power supply and a second switch connected between a second end of the second inductor and the electrode; and
applying a third voltage that is lower than the first voltage to the electrode,
wherein the applying of the third voltage includes absorbing resonance energy generated by the second inductor.

13. The method of claim 12, wherein the first and second inductors are identical inductors.

14. A driving apparatus for driving a plasma display device having an electrode, comprising:
a first switch connected between the electrode and a first power supply that applies a first voltage;
a second switch connected between the electrode and a second power supply that applies a second voltage that is lower than the first voltage;
a first inductor connected to a third power supply that applies a third voltage that is an intermediate voltage between the first voltage and the second voltage;
a rising path including a first diode and a third switch coupled in series between the first inductor and the electrode and increasing a voltage of the electrode when the third switch is turned on;
a second inductor connected to the third power supply;
a falling path including a second diode and a fourth switch coupled in series between the second inductor and the electrode, and decreasing a voltage of the electrode when the fourth switch is turned on; and
a clamping circuit unit for absorbing resonance energy generated by the first inductor and the second inductor when the first and second switches are turned on.

15. The driving apparatus of claim 14, wherein the clamping circuit unit includes
a first resistor and a first capacitor coupled in series between the first inductor and the first power supply or the second power supply, and
a second resistor and a second capacitor coupled in series between the second inductor and the first power supply or the second power supply.

16. The driving apparatus of claim 15, further comprising a third diode and a fourth diode coupled to the first resistor and the second resistor in parallel.

17. The driving apparatus of claim 14, wherein the clamping circuit unit includes a first capacitor and a first resistor coupled in series between an anode and a cathode of the first diode, and
a second capacitor and a second resistor coupled in series between an anode and a cathode of the second diode.

18. The driving apparatus of claim 17, further comprising a third diode and a fourth diode coupled to the first resistor and the second resistor in parallel.

19. The driving apparatus of claim 14, wherein the clamping circuit unit includes a first capacitor and a first resistor coupled in series between both ends of the first inductor, and
a second capacitor and a second resistor coupled in series between both ends of the second inductor.

20. The driving apparatus of claim 19, further comprising a third diode and a fourth diode coupled to the first resistor and the second resistor in parallel.

21. The driving apparatus of claim 14, wherein the first and second inductors are identical inductors, the first and second capacitors are identical capacitors, and the first and second resistors are identical resistors.
